(19) United States
(12) Patent Application Publication
(10) Pub. No.: US 2026/0220810 A1
(43) Pub. Date: Jul. 30, 2026

(54) RELIABILITY DETERMINATION SYSTEM, RELIABILITY DETERMINATION METHOD, AND RELIABILITY DETERMINATION APPARATUS

(71) Applicant: NEC Corporation, Tokyo (JP)

(72) Inventor: Takahiro SHIROSHIMA, Tokyo (JP)

(73) Assignee: NEC Corporation, Tokyo (JP)

(21) Appl. No.: 19/148,018

(22) PCT Filed: Jan. 20, 2023
(86) PCT No.: PCT/JP2023/001762

§ 371 Date: Jul. 15, 2025

(51) Int. Cl. G06T 7/73; G05D 1/246

(52) U.S. Cl. CPC G06T 7/73; G05D 1/2462; G06T 2207/30252

(57) ABSTRACT

A reliability determination system acquires an environment image. The environment image shows an environment in which a mobile object moves. The reliability determination system determines an posture to be associated with the environment image by using an environment map. The environment map includes one or more keyframes, postures corresponding to the keyframes, and positions of landmarks corresponding to feature points on the keyframes. The reliability determination system determines the reliability of data included in the environment map on the basis of an update result of this data.

### TECHNICAL FIELD

The present disclosure relates to a reliability determination system, a reliability determination method, and a reliability determination apparatus.

### BACKGROUND ART

Using time-series data of images obtained from a mobile object, a visual simultaneous localization and mapping (V-SLAM) technology for estimating the posture of the mobile object and generating an environment map has been developed. For example, PTL 1 discloses a technique for correcting a three-dimensional map by increasing reliability of a map region created in advance in an environment map and decreasing reliability of a map region added during operation of a system in V-SLAM. PTL 1 discloses a technique in which, on the premise that a predetermined marker is disposed in a real space, a map region closer to the marker is made more reliable in a map region created during operation of a system.

### CITATION LIST

### Patent Literature

PTL 1: JP 2021-106025 A

### SUMMARY OF INVENTION

### Technical Problem

PTL 1 does not mention determination of the reliability of data included in the environment map other than determination of the reliability of the map region based on an index of “whether the map region is a map region created in advance” and determination of the reliability of the map region based on an index of “distance from a marker disposed in advance”. An object of the present disclosure is to disclose a new technology for determining reliability of data included in an environment map.

### Solution to Problem

The present disclosure provides a reliability determination system comprising: an acquisition means for acquiring a first environment image indicating an environment in which a mobile object moves; a posture determination means for determining a posture of a camera corresponding to the first environment image based on an environment map including one or more keyframes which are environment images different from the first environment image, a posture of a camera corresponding to the keyframes, and landmarks corresponding to feature points on the keyframes; and a determining means for determining reliability of data included in the environment map in accordance with an update result of the environment map updated based on a result of the determination.

The present disclosure provides a reliability determination method of the present disclosure is executed by a computer. The reliability determination method includes: an acquisition step of acquiring a first environment image indicating an environment in which a mobile object moves; a posture determination step of determining a posture of a camera corresponding to the first environment image based on an environment map including one or more keyframes which are environment images different from the first environment image, a posture of a camera corresponding to the keyframes, and landmarks corresponding to feature points on the keyframes; and a determining step of determining reliability of data included in the environment map in accordance with an update result of the environment map updated based on a result of the determination.

The present disclosure provides a reliability determination apparatus comprising: an acquisition means for acquiring a first environment image indicating an environment in which a mobile object moves; a posture determination means for determining a posture of a camera corresponding to the first environment image based on an environment map including one or more keyframes which are environment images different from the first environment image, a posture of a camera corresponding to the keyframes, and landmarks corresponding to feature points on the keyframes; and a determining means for determining reliability of data included in the environment map in accordance with an update result of the environment map updated based on a result of the determination.

### Advantageous Effects of Invention

According to the present disclosure, there is provided a new technology for determining reliability of data included in an environment map.

### BRIEF DESCRIPTION OF DRAWINGS

FIG. 1 is a diagram illustrating an outline of an operation of a reliability determination system according to an example embodiment.

FIG. 2 is a block diagram illustrating a functional configuration of the reliability determination system according to the example embodiment.

FIG. 3 is a block diagram illustrating a functional configuration of the reliability determination system that performs map update processing.

FIG. 4 is a block diagram illustrating a functional configuration of a reliability determination apparatus.

FIG. 5 is a diagram illustrating a hardware configuration of a computer that implements the reliability determination system.

FIG. 6 is a flowchart illustrating a flow of processing executed by a reliability determination system 2000 according to the example embodiment.

FIG. 7 is a flowchart more specifically illustrating a flow of processing executed by the reliability determination system.

FIG. 8 is a diagram illustrating a configuration of landmark information.

FIG. 9 is a diagram illustrating a configuration of keyframe information.

FIG. 10 is a flowchart illustrating a flow of posture determination processing.

FIG. 11 is a diagram illustrating feature points and re-projected points.

FIG. 12 is a diagram illustrating a graph representing pairs of feature points and re-projected points.

FIG. 13 is a diagram illustrating a graph including image nodes of keyframes.

FIG. 14 is a flowchart illustrating a flow of map update processing.

FIG. 15 is a flowchart illustrating a flow of processing for determining reliability of a position of a landmark.

FIG. 16 is a flowchart illustrating a flow of processing for determining the reliability of the posture of the keyframe.

### EXAMPLE EMBODIMENT

Hereinafter, example embodiments of the present disclosure will be described in detail with reference to the drawings. In the drawings, the same or relevant elements are denoted by the same reference numerals, and repeated description is omitted as necessary for clarity of description. In addition, unless otherwise described, predetermined values such as predetermined values and thresholds are stored in advance in a storage unit or the like accessible from an apparatus using the values. Furthermore, unless otherwise described, the storage unit includes one or more storage devices of any number.

### <Overview>

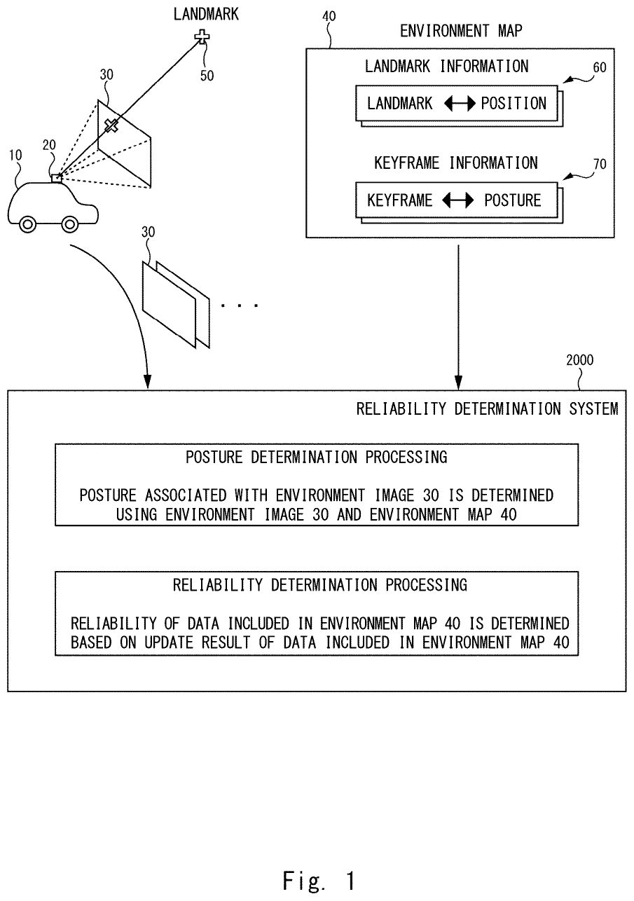

FIG. 1 is a diagram illustrating an outline of a reliability determination system 2000 according to an example embodiment. Here, FIG. 1 is a diagram for facilitating understanding of the outline of the reliability determination system 2000, and the operation of the reliability determination system 2000 is not limited to that illustrated in FIG. 1.

The reliability determination system 2000 performs posture determination processing of determining a posture to be associated with an environment image and reliability determination processing of determining reliability of data 30 included in an environment map 40. The environment image 30 is an image indicating an environment in which a mobile object 10 travels. The input image 30 is, for example, a captured image generated by a camera 20. The camera 20 is provided in the mobile object 10. The mobile object 10 is, for example, a robot, a vehicle, a flying object, or the like. The vehicle is, for example, an automobile, a motorcycle, or the like. The flying object is, for example, a drone. The mobile object 10 may be an object that moves autonomously or may be an object that moves according to an operation by an operator. The mobile object 10 may be an object capable of both autonomous movement and movement according to an operation.

The reliability determination system 2000 acquires the environment image 30 generated by the camera 20. The environment image 30 is included in, for example, time-series data of the captured images generated by the camera 20. For example, in a case where the camera 20 is a 30 frame per second (fps) video camera, the reliability determination system 2000 can obtain thirty environment images 30 per second. However, the reliability determination system 2000 may acquire only a part of the captured images among the plurality of captured images generated by the camera 20 as the environment image 30. For example, in a case where the camera 20 is a 30 fps-video camera, the reliability determination system 2000 can acquire the environment image 30 at a rate of ten images per second by acquiring the captured image generated by the camera 20 at a rate of one image per three images.

The environment map 40 includes landmark information 60 and keyframe information 70. The keyframe is a captured image generated by the camera 20. As will be described later, a part of the plurality of environment images 30 acquired by the reliability determination system 2000 is added to the environment map 40 as a keyframe. The keyframe information 70 indicates a corresponding posture for each of the plurality of keyframes. The posture corresponding to the keyframe is the posture of the camera 20 at the time when the keyframe is generated.

Here, the posture of the camera 20 is represented by, for example, a combination of the position and orientation of the camera 20. The position of the camera 20 is represented by three-dimensional coordinates representing the position of the camera 20 in a specific three-dimensional space. The orientation of the camera 20 is represented by, for example, a combination of an azimuth angle and an elevation angle of the camera 20 in the three-dimensional space. Hereinafter, the “posture corresponding to the captured image” is also expressed as the “posture of the captured image”. Therefore, the “posture corresponding to the keyframe” is also expressed as the “posture of the keyframe”. Similarly, the “posture corresponding to the environment image 30” is also expressed as the “posture of the environment image 30”. The posture of the camera 20 may be represented by either the position of the camera 20 or the orientation of the camera 20.

The landmark information 60 indicates the position of each of one or more landmarks 50. The landmark 50 is a point in the three-dimensional space corresponding to the feature point included in the keyframe. In other words, the landmark 50 is a point on the object imaged on the keyframe and is a point corresponding to the feature point included in the keyframe. Here, the feature point is a characteristic point detected from the image. For example, the feature point is detected according to a gradient of luminance in the image, a change amount of a feature in the image, or the like. The position of the landmark 50 is represented by, for example, three-dimensional coordinates representing the position of the landmark 50 in the three-dimensional space. The landmark 50 can also be expressed as a feature point whose three-dimensional position is determined among the feature points detected from the environment image.

Hereinafter, the fact that the landmark L corresponds to the feature point included in a captured image I is also expressed as “the landmark L is observed in the captured image I” or “the captured image I observes the landmark L”. The reliability determination system 2000 performs posture determination processing on the environment image 30 by using the environment image 30 and the environment map 40. For example, the reliability determination system 2000 determines the posture to be associated with the environment image 30 using a method such as bundle adjustment.

The reliability determination system 2000 further performs reliability determination processing of determining reliability of data included in the environment map 40. The data for which the reliability is to be determined is, for example, the position of the landmark 50. In addition, for example, the target data for determining the reliability is the posture corresponding to the keyframe.

The reliability of the data included in the environment map 40 is determined based on a result of updating the data. For example, when the position of the landmark 50 is updated, if the amount of change in the position of the landmark 50 due to the update is small, it is highly probable that the position of the landmark 50 is accurately estimated. Therefore, for example, the reliability determination system 2000 determines the reliability of the landmark 50 based on the amount of change in the position of the landmark 50 due to the update.

Similarly, when the posture of the keyframe is updated, if the amount of change in the posture of the keyframe due to the update is small, it is highly probable that the posture of the keyframe is accurately estimated. Therefore, for example, the reliability determination system 2000 determines the reliability of the keyframe based on the amount of change in the posture of the keyframe due to the update.

One or more of the plurality of environment images 30 acquired by the reliability determination system 2000 may be added to the environment map 40 as a new keyframe. The reliability determination system 2000 may perform map update processing in a case where the environment image 30 is added to the environment map 40 as a new keyframe. For example, the reliability determination system 2000 updates the environment map 40 by updating the position of the landmark 50 and the posture of the keyframe using a method such as bundle adjustment.

### Example of Operation and Effect

According to the reliability determination system 2000, the reliability of data is determined based on the update result of data included in the environment map 40. As described above, according to the reliability determination system 2000, a new technology for determining the reliability of data included in the environment map 40 is provided.

Here, among the data included in the environment map 40, there is data that is repeatedly updated based on the result of sensing using the camera 20, that is, the environment image 30 obtained from the camera 20, such as the position of the landmark 50 and the posture of the keyframe. Since the value of data repeatedly updated in this manner repeatedly changes, it is difficult to determine the reliability in advance. It is difficult to determine the reliability of data that is not included in the environment map 40 at first and is dynamically generated as a result of sensing using the camera 20 in advance.

In this regard, according to the reliability determination system 2000, the reliability of the data whose value is updated among the data included in the environment map 40 is dynamically determined. Therefore, the reliability can be easily determined even for data to be updated. Since the reliability is dynamically determined, the reliability can be easily determined even for dynamically generated data. Furthermore, since the reliability is determined based on the update result of the data, the reliability of the data can be determined more accurately as compared with a case where the reliability is determined for the data in advance.

Here, determining the reliability of the data included in the environment map 40 has an effect that, for example, the accuracy of processing in which the data included in the environment map 40 is used can be made higher than the accuracy of the processing in a case where the reliability of the data is not determined. For example, by performing the map update processing using the keyframe or the landmark with high reliability, the accuracy of the map update processing can be made higher than the accuracy of the map update processing in a case where the keyframe or the landmark with high reliability is not used. A similar effect can be obtained in the posture update processing.

As described above, in order to increase the accuracy of the processing in which the data included in the environment map 40 is used, the reliability of the data included in the environment map 40 may be accurately determined. According to the reliability determination system 2000, the reliability of the data included in the environment map 40 is determined more accurately than a case where the reliability is determined in advance. Therefore, according to the reliability determination system 2000, the accuracy of the processing using the data included in the environment map 40 can be more reliably increased as compared with the accuracy of the processing in a case where the reliability of the data included in the environment map 40 is determined in advance.

Hereinafter, the reliability determination system 2000 of the present example embodiment will be described in more detail.

### Example of Functional Configuration

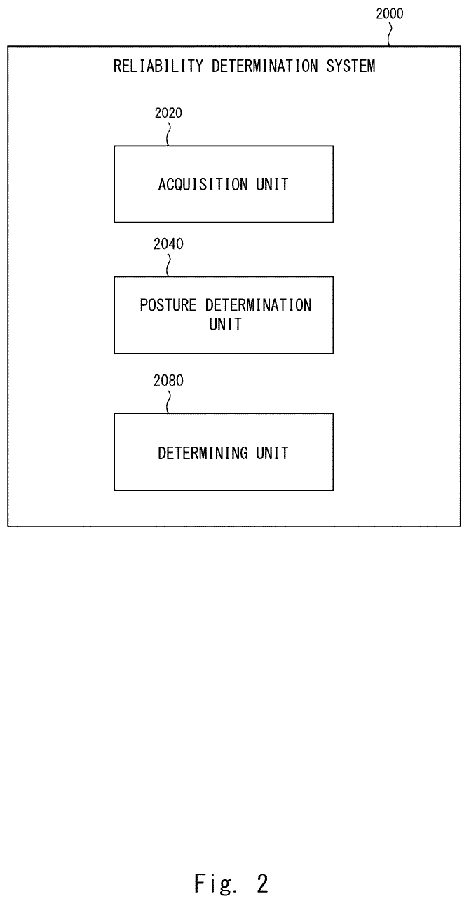

FIG. 2 is a block diagram illustrating a functional configuration of the reliability determination system 2000 according to the example embodiment. The reliability determination system 2000 includes an acquisition unit 2020, a posture determination unit 2040, and a determining unit 2080. The acquisition unit 2020 acquires the environment image 30. The posture determination unit 2040 executes determination processing for determining the position of the environment image 30 using the environment map 40. The determining unit 2080 calculates the reliability of the data included in the environment map 40 based on the update result of the data included in the environment map 40.

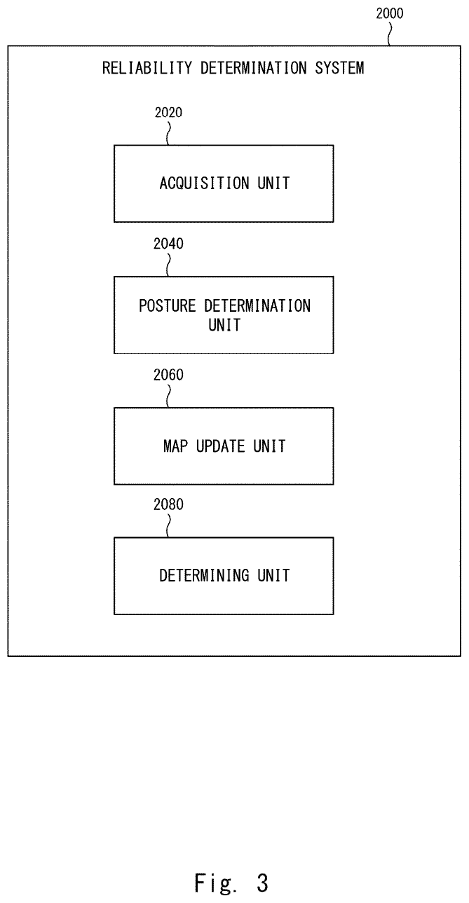

In a case where the reliability determination system 2000 further performs map update processing, the reliability determination system 2000 further includes a functional component unit that performs map update processing. FIG. 3 is a block diagram illustrating a functional configuration of the reliability determination system 2000 that performs map update processing. In FIG. 3, the reliability determination system 2000 further includes a map update unit 2060. In a case where the environment image 30 is added to the environment map 40 as a new keyframe, the map update unit 2060 executes map update processing of updating the position of the keyframe and the position of the landmark 50.

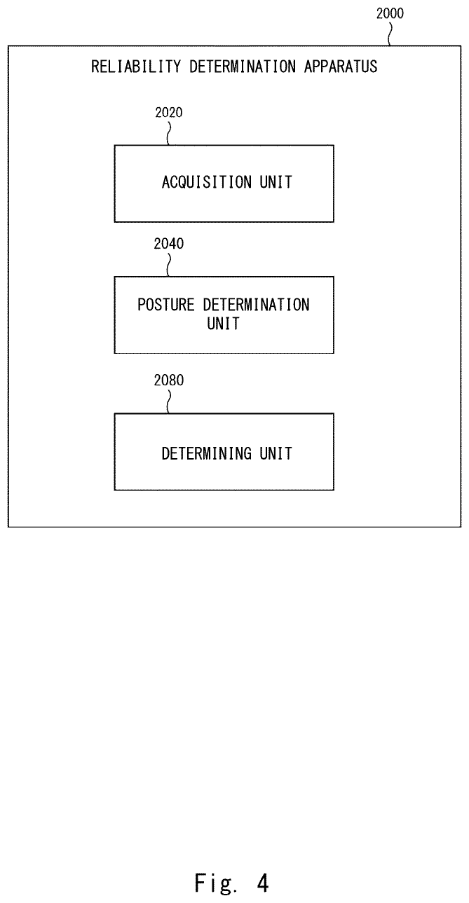

Each functional component included in the reliability determination system 2000 may be implemented by one apparatus. An apparatus in which each functional component included in the reliability determination system 2000 is implemented is referred to as a reliability determination apparatus. FIG. 4 is a block diagram illustrating a functional configuration of the reliability determination apparatus. Similarly to the reliability determination system 2000, a reliability determination apparatus 3000 includes an acquisition unit 2020, a posture determination unit 2040, and a determining unit 2080. The reliability determination apparatus 3000 that executes the map update processing further includes a map update unit 2060 similarly to the reliability determination system 2000 of FIG. 3.

### Example of Hardware Configuration

Each functional component of the reliability determination system 2000 may be implemented by hardware (for example, a hard-wired electronic circuit or the like) that achieves each functional configuration unit, or may be implemented by a combination of hardware and software (for example, a combination of an electronic circuit and a program that controls the electronic circuit or the like). Hereinafter, a case where each functional component of the reliability determination system 2000 is implemented by a combination of hardware and software will be further described.

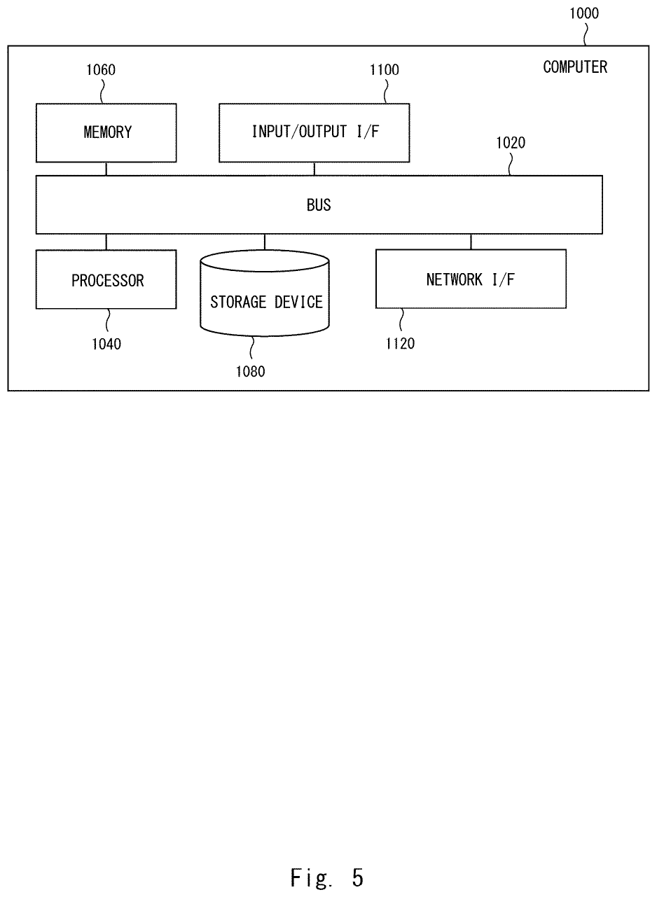

FIG. 5 is a diagram illustrating a hardware configuration of a computer 1000 that implements the reliability determination system 2000. The computer 1000 is any computer. The computer 1000 may be provided inside the mobile object 10 or may be provided outside the mobile object 10. In a case where the computer 1000 is provided inside the mobile object 10, for example, the computer 1000 is a computer that achieves a control apparatus that controls the operation of the mobile object 10 or a computer that achieves a navigation apparatus provided in the mobile object 10. The computer that implements the control apparatus is, for example, a semiconductor chip such as a system on chip (SoC). In a case where the computer 1000 is provided outside the mobile object 10, for example, the computer 1000 is a personal computer (PC), a server machine, a mobile terminal, or the like. The computer 1000 may be a special purpose computer designed to achieve the reliability determination system 2000, or may be a general-purpose computer.

For example, by installing a predetermined application in the computer 1000, each function of the reliability determination system 2000 is implemented in the computer 1000. The above-described application is configured by a program for achieving the functional components of the reliability determination system 2000. The method of acquiring the program is arbitrary. For example, the program can be acquired from a storage medium (a DVD disk, a USB memory, or the like) in which the program is stored. In addition, for example, the program can be acquired by downloading the program from a server apparatus that manages a storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, the method of connecting the processor 1040 and the like to each other is not limited to the bus connection.

The processor 1040 is any of processors such as a central processing unit (CPU), a graphics processing unit (GPU), a field-programmable gate array (FPGA), or a digital signal processor (DSP). The memory 1060 is a primary storage device implemented by using a random access memory (RAM) or the like. The storage device 1080 is an auxiliary storage device implemented using a hard disk, a solid state drive (SSD), a memory card, a read only memory (ROM), or the like.

The input/output interface 1100 is an interface connecting the computer 1000 with an input/output device. For example, an input device such as a keyboard and an output device such as a display device are connected to the input/output interface 1100.

The network interface 1120 is an interface connecting the computer 1000 to a network. The network may be a local area network (LAN) or a wide area network (WAN).

The storage device 1080 stores a program (program for achieving the above-described application) for achieving each functional component of the reliability determination system 2000. The processor 1040 loads the program onto the memory 1060 and executes the program to achieve each functional component of the reliability determination system 2000.

The reliability determination system 2000 may be implemented by one computer 1000 or may be implemented by a plurality of computers 1000. In the latter case, the configurations of the computers 1000 do not need to be the same, and can be different from each other.

As described above, each functional component included in the reliability determination system 2000 can be implemented by one apparatus called the reliability determination apparatus 3000. The hardware configuration of the reliability determination apparatus 3000 is similar to the hardware configuration of the reliability determination system 2000.

### <Flow of Processing>

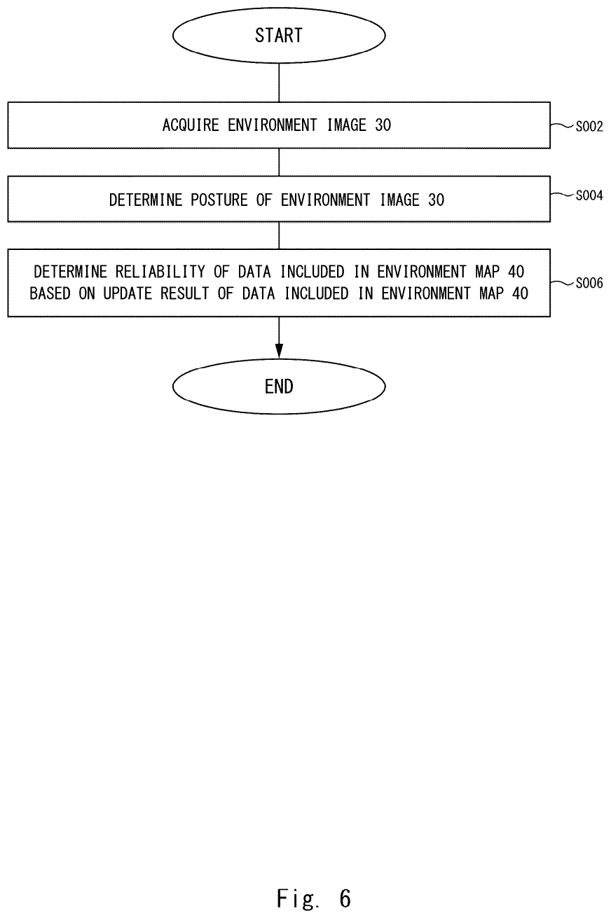

FIG. 6 is a flowchart illustrating a flow of processing executed by the reliability determination system 2000 of the example embodiment. The acquisition unit 2020 acquires the environment image 30 (S002). The posture determination unit 2040 executes determination processing for determining the position of the environment image 30 using the environment map 40 (S004). The determining unit 2080 calculates the reliability of the data included in the environment map 40 based on the update result of the data included in the environment map 40 (S006).

Here, an example of a flow of processing executed by the reliability determination system 2000 will be described more specifically. In this example, the reliability determination system 2000 further executes map update processing.

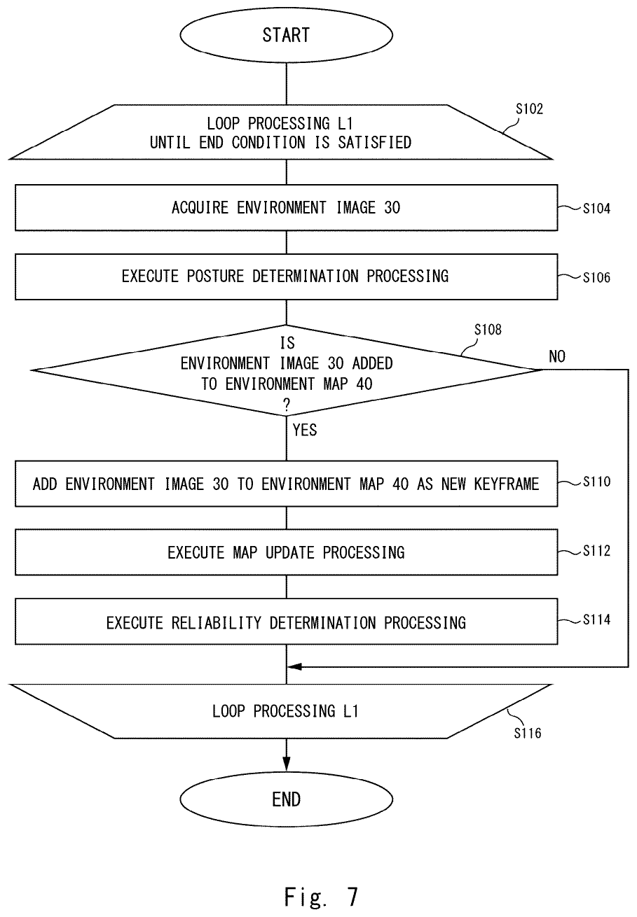

FIG. 7 is a flowchart more specifically illustrating a flow of processing executed by the reliability determination system 2000 of the example embodiment. S102 to 118 constitute loop processing L1 that is repeatedly executed until a predetermined end condition is satisfied. In S102, the reliability determination system 2000 determines whether a predetermined end condition is satisfied. In a case where the predetermined end condition is not satisfied, the processing of FIG. 7 proceeds to S104. On the other hand, in a case where the predetermined end condition is satisfied, the processing of FIG. 7 ends.

As the end condition, various conditions can be used. For example, the end condition is a condition that “a predetermined user operation is performed”. In addition, for example, the end condition is a condition “the operation of the mobile object 10 ends”.

The acquisition unit 2020 acquires the environment image 30 (S104). The posture determination unit 2040 executes posture determination processing (S106). The map update unit 2060 determines whether to add the environment image 30 to the environment map 40 as a new keyframe (S108). In a case where it is determined that “the environment image 30 is not added to the environment map 40 as a new keyframe” (S108: NO), the processing of FIG. 7 proceeds to S116. Since S116 is the end of the loop processing L1, the processing in FIG. 7 proceeds to S102.

In a case where it is determined that “the environment image 30 is added to the environment map 40 as a new keyframe” (S108: YES), the map update unit 2060 adds the environment image 30 to the environment map 40 as a new keyframe (S110). The map update unit 2060 executes map update processing (S112). The determining unit 2080 executes reliability determination processing (S114). Since S116 is the end of the loop processing L1, the processing in FIG. 7 proceeds to S102.

The flow of processing executed by the reliability determination system 2000 is not limited to the flow illustrated in FIG. 7. For example, in the flowchart of FIG. 7, the reliability determination processing is performed every time the map update processing is executed. However, the reliability determination processing is not necessarily executed every time the map update processing is executed. For example, the reliability determination processing may be executed every time the map update processing is executed a predetermined number of times.

In a case where the result of the map update processing is not used for the reliability determination processing and the result of the posture determination processing is used, the reliability determination processing may be executed immediately after the posture determination processing (S106).

### <Environment Map 40>

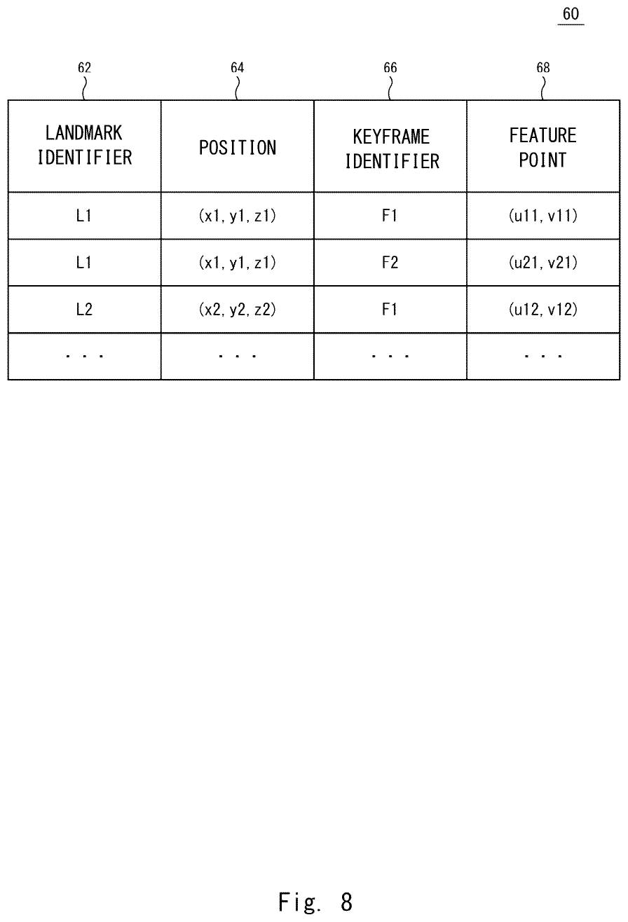

Here, the environment map 40 will be described in more detail. As described above, the environment map 40 includes the landmark information 60 and the keyframe information 70. FIG. 8 is a diagram illustrating a configuration of landmark information 60. The landmark information 60 includes four columns of a landmark identifier 62, a position 64, a keyframe identifier 66, and a feature point 68. The landmark identifier 62 indicates an identifier assigned to the landmark 50. The position 64 indicates a three-dimensional position of the landmark 50. The keyframe identifier 66 indicates an identifier of a keyframe having a feature point corresponding to the landmark 50. The feature point 68 indicates the position of the feature point on the corresponding keyframe. For example, the first line of the landmark information 60 in FIG. 8 indicates that the three-dimensional position of the landmark L1 is (x1, y1, z1) and that the feature point (u11, v11) on the keyframe F1 corresponds to the landmark L1.

One landmark 50 may correspond to a feature point of each of a plurality of keyframes. For example, in the example of FIG. 8, each of the feature point (u11, v11) on the keyframe F1 and the feature point (u21, v21) on the keyframe F2 corresponds to the landmark L1. Therefore, the landmark information 60 in FIG. 8 includes (L1, (x1, y1, z1), F1, (u11, v11)) and (L1, (x1, y1, z1), F2, (u21, v21)) as records indicating the landmark L1.

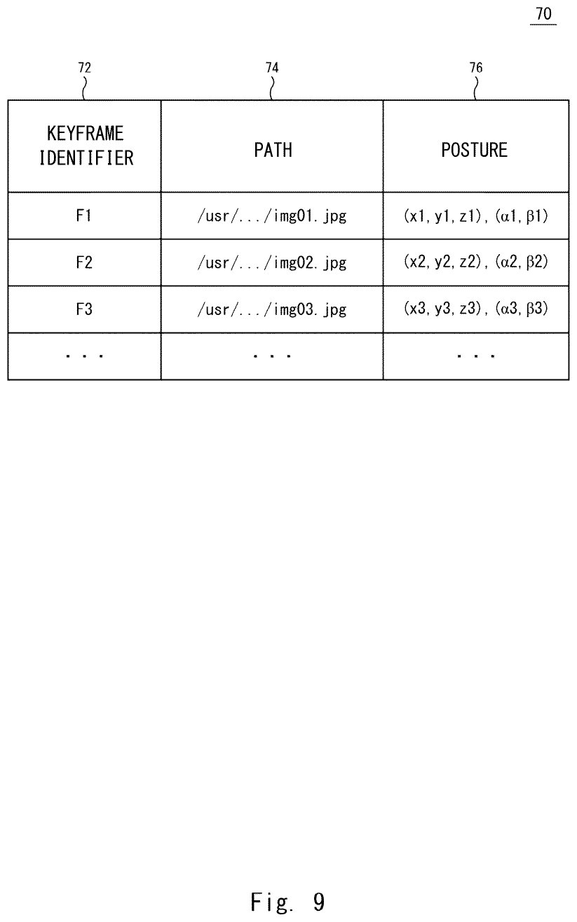

FIG. 9 is a diagram illustrating a configuration of the keyframe information 70. The keyframe information 70 has three columns of a keyframe identifier 72, a path 74, and a posture 76. The keyframe identifier 72 indicates an identifier allocated to the keyframe. The path 74 represents a path of an image file of the keyframe. The posture 76 represents the posture of the keyframe. For example, the first line of FIG. 9 indicates that ‘The keyframe F1 is an image file specified by a path “usr/ . . . /img01.jpg”’ and that ‘The posture of the keyframe F1 is the position (x1, y1, z1) and the orientation (α1, β1)’. Here, the orientation is represented by a combination of an azimuth angle and an elevation angle.

### <Acquisition of Environment Image 30: S002, S104>

The acquisition unit 2020 acquires the environment image 30 (S002, S104). There are various methods for the acquisition unit 2020 to acquire the environment image 30. For example, the environment image 30 is transmitted from the camera 20 to the reliability determination system 2000. In this case, the acquisition unit 2020 acquires the environment image 30 by receiving the environment image 30 transmitted from the camera 20. The environment image 30 may be transmitted by other than the reliability determination system 2000. For example, an apparatus other than the camera 20 provided in the mobile object 10 may transmit the environment image 30 to the reliability determination system 2000. For example, this apparatus is a control apparatus that controls the operation of the mobile object 10.

In addition, for example, the camera 20 stores the environment image 30 in a storage unit accessible from the reliability determination system 2000. In this case, the acquisition unit 2020 acquires the environment image 30 by reading the environment image 30 from the storage unit.

As described above, the camera 20 generates the plurality of environment images 30. The reliability determination system 2000 may acquire the environment images 30 one by one, or may acquire two or more environment images 30 collectively.

### <Posture Determination Processing: S004, S106>

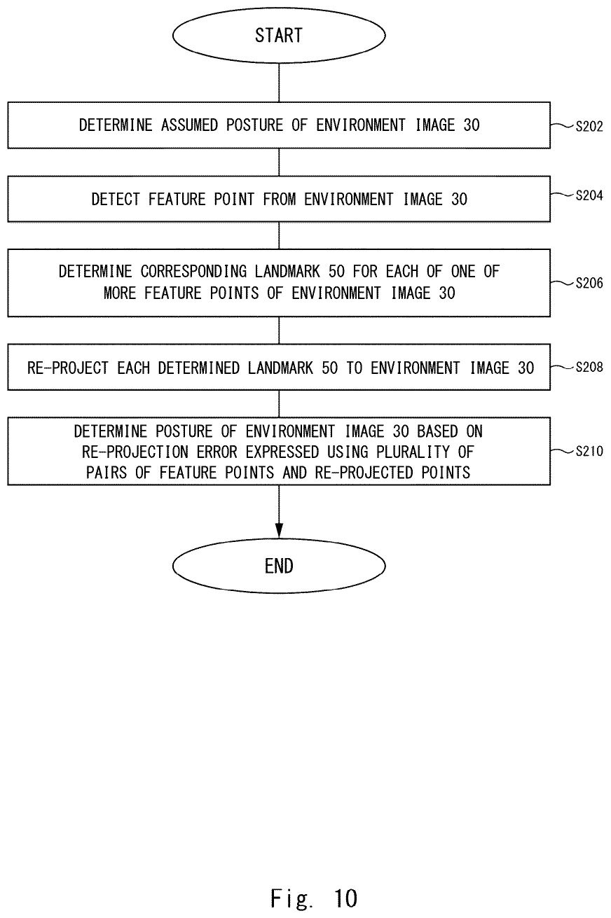

The posture determination unit 2040 executes posture determination processing for determining the posture of the environment image 30 (S004, S106). Hereinafter, the posture determination processing will be specifically exemplified. FIG. 10 is a flowchart illustrating a flow of posture determination processing. The posture determination unit 2040 associates an assumed posture with the environment image 30 (S202). Here, the associated posture is also expressed as an “assumed pose”. Here, an existing method used in V-SLAM or the like can be used as a method of determining an assumed posture for a new environment image.

The posture determination unit 2040 detects a plurality of feature points from the environment image 30 (S204). The posture determination unit 2040 determines the corresponding landmark 50 for one or more feature points included in the environment image 30 (S206). The landmark 50 corresponding to the feature point of the environment image 30 can be determined, for example, by performing feature point matching between the environment image 30 and the keyframe. Specifically, in a case where the feature point P1 of the environment image 30 matches the feature point Q1 of a certain keyframe, the posture determination unit 2040 determines the landmark 50 corresponding to the feature point Q1 of the keyframe as the landmark 50 corresponding to the feature point P1 of the environment image 30. Here, as described above, the information of the landmark 50 corresponding to the feature point of the keyframe is indicated in the landmark information 60.

Some of the feature points included in the environment image 30 may not correspond to any of the landmarks 50 included in the environment map 40. As will be described later, for a feature point of the environment image 30 that does not correspond to any landmark 50 included in the environment map 40, a corresponding landmark 50 can be newly generated by the map update processing.

The posture determination unit 2040 re-projects each determined landmark 50 onto the environment image 30 (S208). Here, the process of “re-projecting the landmark 50 onto the captured image” is a process of determining a theoretical point on the captured image at which the landmark 50 is observed by projecting the landmark 50 onto the captured image on the assumption that both the posture of the captured image and the three-dimensional position of the landmark 50 are correct. The theoretical point is also expressed as a “re-projected point”. Here, the process of “projecting the landmark 50 onto the captured image” is a process of virtually disposing each of the landmark, the captured image, and a camera having a posture associated with the captured image on a three-dimensional space, and calculating a point at which a straight line connecting the camera and the landmark passes through the captured image. By this re-projection, for each landmark 50 observed by the environment image 30, the posture determination unit 2040 obtains a pair of a feature point on the environment image 30 corresponding to the landmark 50 and a re-projected point on the environment image 30 obtained by the re-projection of the landmark 50.

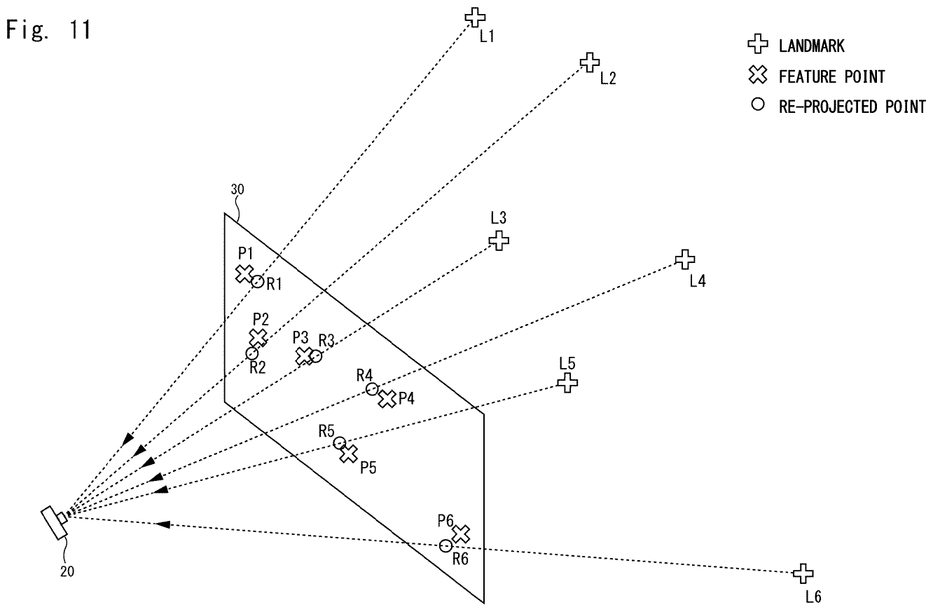

FIG. 11 is a diagram illustrating a feature point and a re-projected point. In the example of FIG. 11, the corresponding landmarks L1 to L6 are determined for the feature points P1 to P6 detected from the environment image 30. Then, the re-projected points R1 to R6 are obtained by re-projecting each of the landmarks L1 to L6 onto the environment image 30. Therefore, six pairs of (P1, R1), (P2, R2), (P3, R3), (P4, R4), (P5, R5), and (P6, R6) are obtained as pairs of feature points and re-projected points.

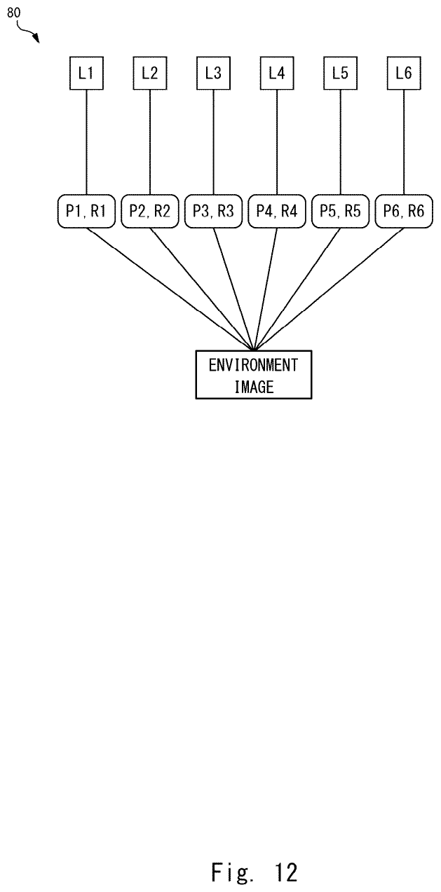

Pairs of feature points and re-projected points can also be represented graphically. FIG. 12 is a diagram illustrating a graph representing pairs of feature points and re-projected points. In the graph 80 of FIG. 12, the uppermost node and the lowermost node represent the landmark 50 and the captured image. Hereinafter, the uppermost node and the lowermost node are also referred to as a “landmark node” and an “image node”. The graph 80 of FIG. 12 has a node of the environment image 30 as an image node.

The landmark node and the image node are connected by a “side”. The side indicates that the feature point on the image node corresponds to the landmark having the three-dimensional position.

For example, in the graph 80 of FIG. 12, the image node of the environment image 30 and the landmark node of the landmark L1 are connected by the side representing the pair (P1, R1). This indicates that the feature point P1 included in the environment image 30 corresponds to the landmark L1, and that the re-projected point R1 is obtained by re-projecting the landmark L1 onto the environment image 30.

The posture determination unit 2040 determines the posture of the environment image 30 based on the re-projection error obtained from each of the plurality of pairs of the feature point and the re-projected point (S210). Here, a re-projection error obtained from a pair of a feature point and a re-projected point is represented by a distance between the feature point and the re-projected point. For example, the posture determination unit 2040 determines the posture of the environment image 30 that minimizes the objective function determined based on the re-projection error, and determines the determined posture as the posture to be associated with the environment image 30.

The posture determination unit 2040 determines a value of each piece of data that minimizes the objective function by adjusting a value of one or more pieces of data that affect the magnitude of the re-projection error. As described above, a method called bundle adjustment or the like can be applied to the processing of determining the value of each piece of data that minimizes the objective function based on the re-projection error by adjusting the value of each piece of data that affects the magnitude of the re-projection error.

The data to be adjusted may be only the posture of the environment image 30 or may include data other than the posture of the environment image 30. In the latter case, for example, the data to be adjusted includes the position of each landmark 50 observed by the environment image 30. In this case, by adjusting the posture of the environment image 30 and the position of each landmark 50, the posture determination unit 2040 determines the posture of the environment image 30 and the position of each landmark 50 that minimize the objective function based on the re-projection error.

In addition, for example, the data to be adjusted includes the posture of the keyframe. In this case, the posture determination unit 2040 re-projects the landmark 50 also for the keyframe in addition to the environment image 30, thereby obtaining a pair of the feature point included in the keyframe and the re-projected point of the landmark 50 corresponding to the feature point. As described above, the case of obtaining the pair of the feature point and the re-projected point also for the keyframe can be expressed by adding the image node of the keyframe to the graph 80 described above.

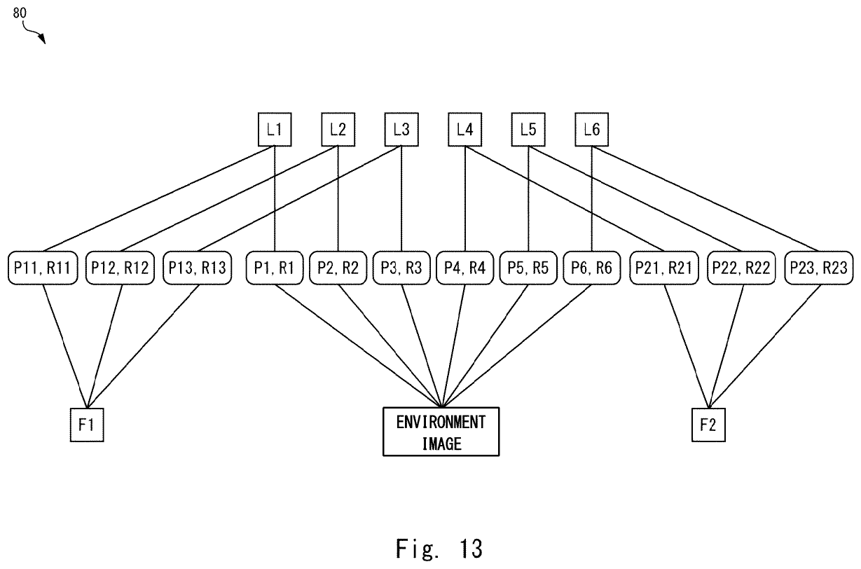

FIG. 13 is a diagram illustrating a graph 80 including image nodes of keyframes. The graph 80 of FIG. 13 has an image node for each of the keyframe F1 and the keyframe F2. Here, in the graph 80 of FIG. 13, one landmark node is connected to two sides. This indicates that one landmark 50 is observed by two captured images. For example, the landmark node of the landmark L1 is connected to the image node of the keyframe F1 with a side representing a pair (P11, R11). Furthermore, the landmark node of the landmark L1 is connected to the image node of the environment image 30 by a side representing a pair (P1, R1). These connection relationships indicate that the feature point P11 on the keyframe F1 and the feature point P1 on the environment image 30 match each other, and the landmark 50 corresponding to these feature points is L1.

For the graph 80 in FIG. 13, the posture determination unit 2040 determines the posture of the environment image 30 and the posture of each keyframe that minimize the objective function for the objective function based on the re-projection error obtained from the pair of the feature point and the re-projected point represented by each side. As a result, the posture of the environment image 30 is determined. The posture of each keyframe is updated in the environment map 40.

Here, either one of the position of the landmark and the posture of the keyframe may be treated as an adjustment target, or both may be treated as adjustment targets. For the graph 80 in FIG. 13, in a case where both the position of the landmark and the posture of the keyframe are to be adjusted, the posture determination unit 2040 determines the posture of the environment image 30. The posture of each keyframe, and the position of each landmark 50 that minimize the objective function for the objective function based on the re-projection error obtained from the pair of the feature point and the re-projected point represented by each side. As a result, the posture of the environment image 30 is determined. In the environment map 40, the posture of each keyframe and the position of each landmark 50 are updated.

### <Addition of Environment Image 30 to Environment Map 40: S108, S110>

The map update unit 2060 determines whether to add the environment image 30 to the environment map 40 as a new keyframe (S108). Here, various conditions can be adopted as conditions for adding the environment image 30 to the environment map 40 as a new keyframe. Hereinafter, the condition for adding the environment image 30 as a new keyframe to the environment map 40 is also referred to as an “addition condition”.

For example, the addition condition is a condition that “A difference between the posture of the environment image 30 and the posture of the latest keyframe included in the environment map 40 satisfies a predetermined condition”. The predetermined condition is, for example, a condition that “A distance between the position of the environment image 30 and the position of a latest keyframe included in the environment map 40 is equal to or more than a threshold”. In addition, for example, the predetermined condition is a condition that “A difference between the orientation of the environment image 30 and the orientation of the latest keyframe included in the environment map 40 is equal to or more than a threshold”.

In addition, for example, the addition condition is a condition that “The number of landmarks 50 observed by the environment image 30 is equal to or less than a threshold”.

In a case where it is determined that the environment image 30 is to be added to the environment map 40 as a new keyframe (S108: YES), the map update unit 2060 adds the environment image 30 to the environment map 40 as a new keyframe (S110). In this case, the map update unit 2060 adds a record representing the environment image 30 to the keyframe information 70. The keyframe identifier 72 of the record to be added indicates a keyframe identifier allocated to the environment image 30. The path 74 of the record to be added indicates a path of the environment image 30. Further, the posture 76 of the record to be added indicates the posture of the environment image 30 determined by the posture determination processing.

Further, the map update unit 2060 adds a record indicating the correspondence relationship between the feature point of the environment image 30 and the landmark 50 to the landmark information 60. Specifically, the correspondence relationship between the feature point on the environment image 30 determined in the posture determination processing and the landmark 50 is added to the landmark information 60. For example, in the example of FIG. 10, the landmarks L1 to L6 are determined as the landmarks 50 corresponding to the feature points P1 to P6 of the environment image 30. Therefore, the map update unit 2060 adds a record indicating the correspondence relationship to the landmark information 60.

### <Map Update Processing: S112>

In a case where the environment image 30 is added to the environment map 40 as a keyframe, the map update unit 2060 updates the environment map 40 (S112). Hereinafter, the environment image 30 added as a keyframe to the environment map 40 is also referred to as a new keyframe. A keyframe other than the new keyframe among the keyframes included in the environment map 40 is also referred to as an existing keyframe. The update of the environment map 40 includes update of the posture of the keyframe and update of the position of the landmark 50. The keyframe to be updated includes not only an existing keyframe but also a new keyframe.

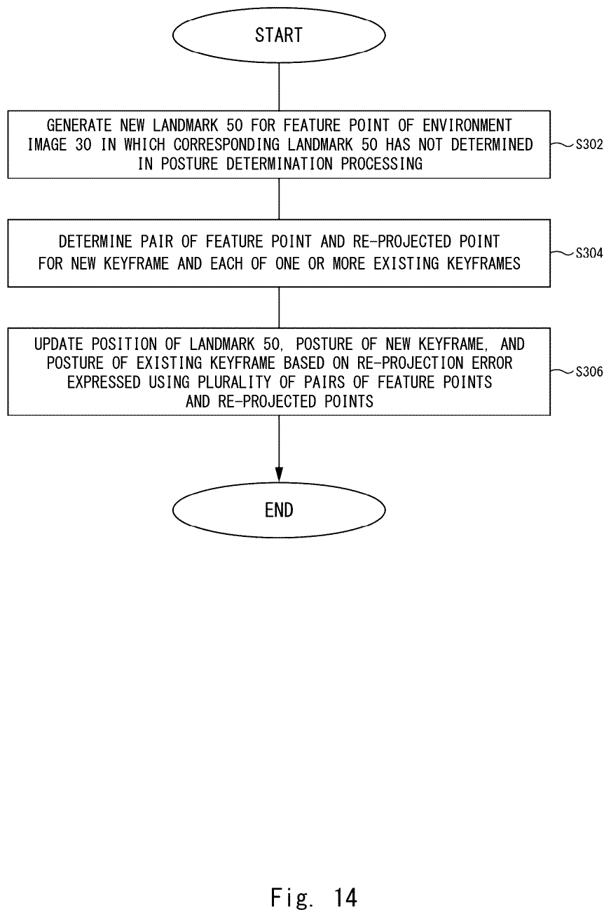

For example, the map update unit 2060 executes map update processing as follows. FIG. 14 is a flowchart illustrating a flow of map update processing. The map update unit 2060 newly generates the landmark 50 for one or more feature points for which the corresponding landmark 50 has not been determined in the posture determination processing among the feature points included in the new keyframe (S302).

The position of the new landmark 50 can be determined using, for example, triangulation. Specifically, the map update unit 2060 performs the feature point matching between the new keyframe and the existing keyframe, thereby detecting the feature point of the existing keyframe matching the feature point of the new keyframe in which the corresponding landmark 50 is not determined. Then, the map update unit 2060 determines the three-dimensional position represented by these feature points by triangulation based on the posture of the new keyframe, the position of the feature point in the new keyframe, the posture of the existing keyframe, and the position of the feature point in the existing keyframe. Then, the determined three-dimensional position is determined as the position of the new landmark 50 corresponding to these feature points. The information of the new landmark 50 is added to the landmark information 60.

For example, it is assumed that the feature point (ui, vi) of the new keyframe Fi and the feature point (uj, vj) of the existing frame Fj match each other, and (xk, yk, zk) is determined as the three-dimensional position corresponding to these feature points. Further, it is assumed that the map update unit 2060 allocates the identifier Lk to the newly generated landmark 50. In this case, the map update unit 2060 adds a record of “landmark identifier 62=Lk, position 64=(xk, yk, zk), keyframe identifier 66=Fi, feature point 68=(ui, vi);” and a record of “landmark identifier 62=Lk, position 64=(xk, yk, zk), keyframe identifier 66=Fj, feature point 68=(uj, vj);” to the landmark information 60.

The map update unit 2060 generates pairs of feature points and re-projected points for each of the new keyframes and one or more existing keyframes used for updating the environment map 40 (S304). As a result, a graph 80 similar to the graph 80 illustrated in FIG. 13 is obtained.

The map update unit 2060 updates the position of the landmark 50, the posture of the new keyframe, and the posture of the existing keyframe based on the re-projection error of each pair of the feature point and the re-projected point (S306). For example, the map update unit 2060 determines the position of the landmark 50, the posture of the new frame, and the posture of the existing keyframe that minimize the objective function determined based on the re-projection error, and updates the environment map 40 with the determined values. As described above, a method such as bundle adjustment can be used as a method of determining the position of the landmark 50 and the posture of the image that minimize the objective function determined based on the re-projection error.

Here, the map update unit 2060 may update the position of the landmark 50 or the like based on the re-projection error, calculate the re-projection error again for each pair of feature points and re-projected points, and exclude the landmark 50 having the re-projection error equal to or more than the threshold from the environment map 40. As a result, the landmark 50 having a large error due to the update can be excluded from the environment map 40 as an outlier.

### <Reliability Determination Processing: S006, S114>

The determining unit 2080 determines the reliability of the data included in the environment map 40 based on the update result of the data included in the environment map 40 (S006, S114). As described above, the data for which the reliability is determined is, for example, the posture of the keyframe or the position of the landmark 50. Determination of the reliability of the position of the landmark 50 will be described below.

The position of the landmark 50 can be updated by the map update processing. Therefore, for example, for the position of each landmark 50 to be updated in the map update processing, the determining unit 2080 determines the reliability of the position of the landmark 50 based on the update result. In addition, for example, the position of the landmark 50 can be updated by the posture determination processing. Therefore, for example, for the position of each landmark 50 to be updated in the posture determination processing, the determining unit 2080 determines the reliability of the position of the landmark 50 based on the update result.

Here, in a case where a difference between the position before the update and the position after the update is small for a certain landmark 50, it is highly probable that the position of the landmark 50 is accurately estimated. Therefore, for example, the determining unit 2080 determines the reliability of the position of the landmark 50 based on the difference between the position of the landmark 50 before the update and the position of the landmark 50 after the update. In other words, the determining unit 2080 determines the reliability of the position of the landmark 50 based on the amount of change in the position of the landmark 50 due to the update. The amount of change in the position of the landmark 50 due to the update is represented by, for example, a distance between the position of the landmark 50 before the update and the position of the landmark 50 after the update.

For example, the determining unit 2080 calculates an amount of change in the position due to the update for each landmark 50 to be updated. Then, the determining unit 2080 sets a larger value to the reliability of the position of each landmark 50 as the number of times of updating in which the amount of change in the position is equal to or less than the threshold is larger for each landmark 50. In this way, the reliability of the position becomes higher as the landmark 50 is updated more frequently with a smaller amount of change in the position. For example, the determining unit 2080 adds a predetermined value to the reliability of the position of each landmark 50 every time the update in which the amount of change in the position is small is performed for each landmark 50.

In addition to the process of increasing the reliability of the landmark 50, or instead of the process of increasing the reliability of the landmark 50, the determining unit 2080 may perform a process of decreasing the reliability of the landmark 50. For example, the determining unit 2080 subtracts a predetermined value from the reliability of the position of each landmark 50 every time the update with a large amount of change in the position is performed for each landmark 50. The predetermined value added to the reliability and the predetermined value subtracted from the reliability may be the same value or different values.

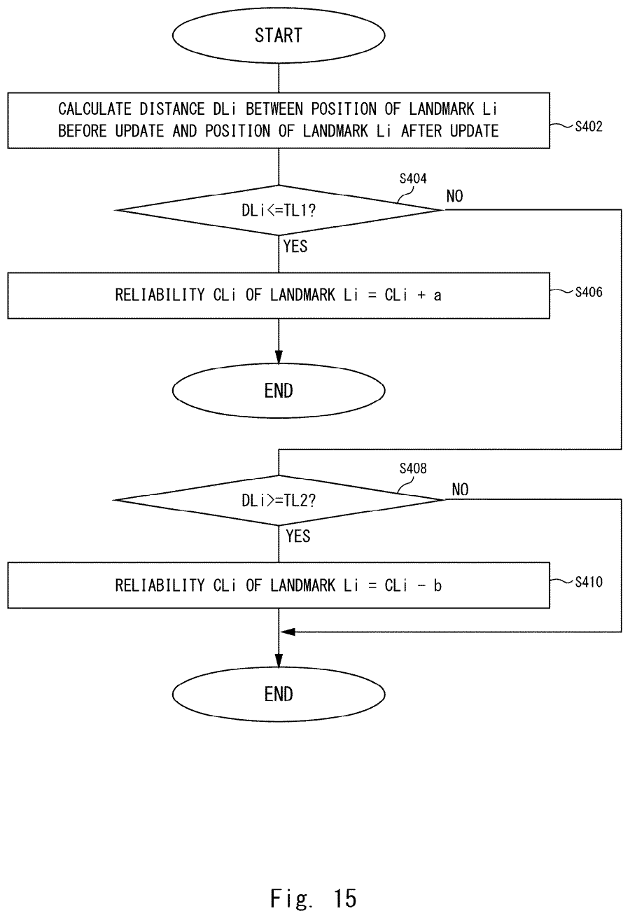

FIG. 15 is a flowchart illustrating a flow of processing for determining the reliability of the position of the landmark 50. The determining unit 2080 executes the process of FIG. 15 for each landmark 50 to be updated. In FIG. 15, the landmark 50 to be subjected to the reliability determination processing is denoted by Li.

The determining unit 2080 calculates a distance DLi between the position of the landmark Li before the update and the position of the landmark Li after the update (S402). The determining unit 2080 determines whether the distance DLi is equal to or less than the threshold TL1 (S404). In a case where the distance DLi is equal to or less than the threshold TL1 (S404: YES), the determining unit 2080 increases the reliability CLi of the landmark Li by a (S406). Here, a>0.

In a case where the distance DLi is not equal to or less than the threshold Th1 (S404: NO), the determining unit 2080 determines whether the distance DLi is equal to or more than the threshold TL2 (S408). Here, TL1<TL2. In a case where the distance DLi is equal to or more than the threshold TL2 (S408: YES), the determining unit 2080 decreases the reliability CLi of the landmark Li by b (S410). Here, b>0. In a case where the distance DLi is not equal to or more than the threshold TL2 (S408: NO), the process of FIG. 15 ends.

The determination of the reliability of the position of the landmark 50 may further take into account the number of keyframes observing the landmark 50. Hereinafter, the number of keyframes observing the landmark L is also expressed as “the number of observations of the landmark L”.

In a case where the number of observations of the landmark 50 is taken into consideration, for example, the reliability of the position of the landmark 50 is represented by (CLi, NOi) which is a combination of the value CLi set based on the amount of change in the position due to the update and the number of observations NOi of the landmark 50. In addition, for example, the reliability of the landmark 50 may be represented by one value calculated based on the above-described value CLi and the number of observations NOi of the landmark 50. In this case, for example, the reliability of the landmark 50 is represented by CLi*NOi which is a value obtained by multiplying CLi by NOi, a weighted sum of CLi and NOi, or the like.

Next, a method of calculating the reliability of the posture of the keyframe will be described. The posture of the keyframe may be updated by map update processing. Therefore, for example, the determining unit 2080 determines the reliability of the posture of each keyframe based on the update result for the posture of each keyframe to be updated in the map update processing. In addition, for example, the posture of the keyframe can be updated by the posture determination processing. Therefore, for example, the determining unit 2080 determines the reliability of the position of the posture of each keyframe based on the update result for the posture of each keyframe to be updated in the posture determination processing.

Here, in a case where the difference between the posture before the update and the posture after the update is small for a certain keyframe, it is highly probable that the posture of the keyframe is accurately estimated. Therefore, the determining unit 2080 determines the reliability of the posture of the keyframe based on the difference between the posture of the keyframe before the update and the posture of the keyframe after the update. In other words, the determining unit 2080 determines the reliability of the posture of the keyframe based on the amount of change in the posture of the keyframe due to the update.

For example, in a case where the posture of the keyframe is updated, the determining unit 2080 calculates the amount of change in the posture of the keyframe. Then, the determining unit 2080 sets a larger value to the reliability of the keyframe as the number of times of updating in which the amount of change in the posture of the keyframe is equal to or less than the threshold is larger. In this way, the more the keyframe is updated with a small amount of change in the posture, the higher the reliability of the posture is. For example, the determining unit 2080 adds a predetermined value to the reliability of the posture of each keyframe every time update with a small amount of change in the posture is performed for each keyframe.

The determining unit 2080 may perform processing of reducing the reliability of the posture of the keyframe in addition to the processing of increasing the reliability of the posture of the keyframe or instead of the processing of increasing the reliability of the posture of the keyframe. For example, the determining unit 2080 subtracts a predetermined value from the reliability of the posture of each keyframe every time update with a large amount of change in the posture is performed for each keyframe. The predetermined value added to the reliability and the predetermined value subtracted from the reliability may be the same value or different values.

Here, there are various methods of representing the amount of change in the posture of the keyframe. For example, the amount of change in the posture of the keyframe is represented by the amount of change in the position of the keyframe. In this case, the determining unit 2080 calculates the distance between the position of the keyframe before the update and the position of the keyframe after the update as a value representing the amount of change in the posture of the keyframe.

In addition, for example, the amount of change in the posture of the keyframe may be represented by the amount of change in the position of the keyframe and the amount of change in the orientation of the keyframe.

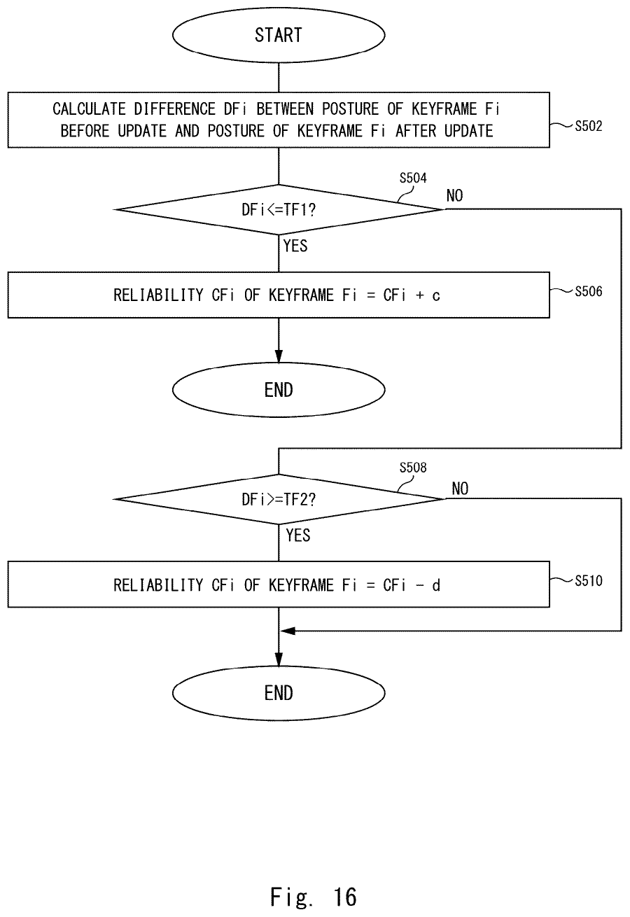

FIG. 16 is a flowchart illustrating a flow of processing for determining the reliability of the posture of the keyframe. The determining unit 2080 executes the processing of FIG. 16 for each keyframe to be updated. In FIG. 16, a keyframe to be subjected to the reliability determination processing is denoted as Fi.

The determining unit 2080 calculates a difference DFi between the posture of the keyframe Fi before the update and the posture of the keyframe Fi after the update (S502). The determining unit 2080 determines whether the difference DFi is equal to or less than the threshold TF1 (S504). In a case where the difference DFi is equal to or less than the threshold TF1 (S504: YES), the determining unit 2080 increases the reliability CFi of the keyframe Fi by c (S506). Here, c>0.

In a case where the difference DFi is not equal to or less than the threshold TF1 (S504: NO), the determining unit 2080 determines whether the difference DFi is equal to or more than the threshold TF2 (S508). Here, TF1<TF2. In a case where the difference DFi is equal to or more than the threshold TF2 (S508: YES), the determining unit 2080 decreases the reliability CFi of the posture of the keyframe Fi by d (S510). Here, d>0. In a case where the difference DFi is not equal to or more than the threshold TF2 (S508: NO), the process of FIG. 16 ends.

The reliability of the position of the landmark 50 observed by the keyframe may be further taken into consideration in determining the reliability of the posture of the keyframe. For example, the determining unit 2080 reflects the number NLi of the landmarks 50 having high reliability of the position among the landmarks 50 observed by the keyframe Fi as the reliability of the posture of the keyframe Fi. For example, the reliability of the posture of the keyframe Fi is represented by (CFi, NLi) which is a combination of the value CFi determined based on the amount of change in the posture and the number NLi of the landmarks 50 having high reliability of the position among the landmarks 50 observed by the keyframe Fi. In addition, for example, the reliability of the posture of the keyframe may be represented by one value calculated based on CFi and NLi. In this case, for example, the reliability of the posture of the keyframe is represented by CFi*NLi which is a value obtained by multiplying CFi by NLi, a weighted sum of CFi and NLi, or the like.

Here, the landmark 50 having high reliability of the position is, for example, the landmark 50 having reliability of the position equal to or more than a predetermined threshold. For example, the determining unit 2080 treats, as NLi, the number of landmarks 50 treated as fixed landmarks to be described later among the landmarks 50 observed by the keyframe Fi.

### <Method of Using Reliability>

The reliability determination system 2000 may use the reliability of the position of the landmark 50, the reliability of the posture of the keyframe, or both. Hereinafter, a method in which the reliability determination system 2000 uses the reliability of the position of the landmark 50 and a method in which the reliability determination system 2000 uses the reliability of the posture of the keyframe will be described.

### <<Processing Using Reliability of Position of Landmark 50>>

For example, the reliability determination system 2000 performs map update processing using the reliability of the position of the landmark 50. Here, in the environment map 40, there may be a landmark 50 whose position has already been accurately estimated. If the accurate position of the landmark 50 is updated by the map update processing as described above, there is a possibility that the position of the landmark 50 moves away from the true value. Therefore, the position of the landmark 50 that has already been accurately estimated with high probability may be not updated by the map update processing.

Therefore, the map update unit 2060 determines whether the position of each landmark 50 used in the map update processing can be updated based on the reliability of the position of the landmark 50. Hereinafter, the landmark 50 whose position has been determined not to be updatable is also referred to as a “fixed landmark”. On the other hand, the landmark 50 whose position has been determined to be updatable is also referred to as a “floating landmark”. Expressed using these terms, the map update unit 2060 determines whether each landmark 50 used in the map update processing is treated as a fixed landmark or a floating landmark.

For example, the map update unit 2060 treats the landmark 50 whose reliability of the position is equal to or less than a threshold as a floating landmark. On the other hand, the landmark 50 whose reliability of the position is larger than the threshold is treated as a fixed landmark.

In addition, for example, in a case where the reliability of the position of the landmark 50 is represented by a combination of the value CLi determined based on the amount of change in position due to the update and the number of observations NOi, the map update unit 2060 may determine whether to treat the landmark 50 as a fixed landmark or a floating landmark by comparing each of CLi and NOi with a threshold. In this case, a threshold is determined in advance for each of CLi and NOi. For example, in a case where both CLi and NOi of the landmark 50 are larger than the threshold, the map update unit 2060 treats the landmark 50 as a fixed landmark. On the other hand, in a case where at least one of CLi and NOi of the landmark 50 is equal to or less than the threshold, the map update unit 2060 treats the landmark 50 as a floating landmark.

The map update unit 2060 performs map update processing on only the floating landmarks under the constraint that “the position of the fixed landmarks is not changed”. For example, in a case where the map update processing is performed using the bundle adjustment based on the re-projection error, the map update unit 2060 performs the bundle adjustment under the constraint that “the position of the fixed landmark is not changed”.

The reliability of the position of the landmark 50 may be used for posture determination processing. Also in the posture determination processing, similarly to the map update processing, the position of the landmark 50 that has already been accurately estimated with high probability may be not updated.

Therefore, the posture determination unit 2040 determines whether each landmark 50 used in the posture determination processing is treated as a fixed landmark or a floating landmark. Then, the posture determination unit 2040 performs posture determination processing under the constraint that “the position of the fixed landmark is not changed”. For example, in a case where posture determination processing is performed using bundle adjustment based on a re-projection error, the posture determination unit 2040 performs bundle adjustment under the constraint that “the position of a fixed landmark is not changed”.

### <<Processing Using Reliability of Posture of Keyframe>>

For example, the reliability determination system 2000 performs map update processing using the reliability of the posture of the keyframe. Here, in the environment map 40, there may be a keyframe whose posture has already been accurately estimated. If the correct posture of the keyframe is updated by the map update processing as described above, there is a possibility that the posture of the keyframe becomes far from the true value. Therefore, the posture of the keyframe, which has already been accurately estimated and has high probability, may be not updated by the map update processing.

Therefore, for each keyframe used in the map update processing, the map update unit 2060 determines whether the posture can be updated based on the reliability of the posture of the keyframe. Hereinafter, the keyframe for which it is determined that the posture cannot be updated is also referred to as a “fixed keyframe”. On the other hand, a keyframe for which it is determined that the posture can be updated is also expressed as a “floating keyframe”. Expressed using these terms, the map update unit 2060 determines whether each keyframe used in the map update processing is to be treated as a fixed keyframe or a floating keyframe.

For example, the map update unit 2060 treats a keyframe whose posture reliability is equal to or less than a threshold as a floating keyframe. On the other hand, a keyframe whose posture reliability is greater than a threshold is treated as a fixed keyframe.

In addition, for example, it is assumed that the reliability of the posture of the keyframe is represented by a combination of a value CFi determined based on the amount of change in the posture due to the update and NLi, which is the number of landmarks 50 having high reliability of the position among the observed landmarks 50. In this case, the map update unit 2060 may compare each of CFi and NLi with a threshold to determine whether to treat the keyframe as a fixed keyframe or a floating keyframe. In this case, a threshold is determined in advance for each of CFi and NLi. For example, in a case where both CFi and NLi of the keyframe are larger than the threshold, the map update unit 2060 treats the keyframe as a fixed keyframe. On the other hand, in a case where at least one of CFi and NLi of the keyframe is equal to or less than the threshold, the map update unit 2060 treats the keyframe as a floating keyframe.

As described above, for example, NLi is the number of landmarks 50 treated as fixed landmarks among the landmarks 50 observed by the keyframe Fi. In this case, for example, in a case where the reliability CFi based on the amount of change in the posture due to the update is larger than the threshold for a certain keyframe and the number of landmarks 50 treated as fixed landmarks among the landmarks 50 observed by the keyframe is larger than a predetermined number, the map update unit 2060 treats the keyframe as a fixed keyframe.

The map update unit 2060 performs map update processing under the constraint that “the posture of the fixed keyframe is not changed”. For example, in a case where the map update processing is performed using the bundle adjustment based on the re-projection error, the map update unit 2060 performs the bundle adjustment under the constraint that “the posture of the fixed keyframe is not changed”.

The reliability of the posture of the keyframe may be used for posture determination processing. Also in the posture determination processing, similarly to the map update processing, the posture of the keyframe that has already been accurately estimated and has high probability may be not updated.

Therefore, the posture determination unit 2040 determines whether each keyframe used in the posture determination processing is treated as a fixed keyframe or a floating keyframe. Then, the posture determination unit 2040 performs posture determination processing under the constraint that “the posture of the fixed keyframe is not changed”. For example, in a case where posture determination processing is performed using bundle adjustment based on a re-projection error, the posture determination unit 2040 performs bundle adjustment under the constraint that “the position of the fixed keyframe is not changed”.

### <<Processing Using Both Reliability of Position of Landmark 50 and Reliability of Posture of Keyframe>>

The map update unit 2060 may perform map update processing using both the reliability of the posture of the keyframe and the reliability of the position of the landmark 50. In this case, the map update unit 2060 determines whether each keyframe used in the map update processing is treated as a fixed keyframe or a floating keyframe. The map update unit 2060 determines whether each landmark 50 used in the map update processing is treated as a fixed landmark or a floating landmark. Then, the map update unit 2060 performs map update processing under the constraint that “The posture of the fixed keyframe is not changed and the position of the fixed landmark is not changed”. For example, in a case where the map update processing is performed using the bundle adjustment based on the re-projection error, the map update unit 2060 performs the bundle adjustment under the constraint that “The posture of the fixed keyframe is not changed and the position of the fixed landmark is not changed”.

Here, it is assumed that the fixed keyframe observes the fixed landmark. In this case, the re-projection error obtained for the pair of the feature point of the fixed keyframe and the re-projected point obtained by re-projecting the fixed landmark onto the fixed keyframe does not change even when bundle adjustment or the like is performed. Therefore, the map update unit 2060 may not include the re-projection error obtained from the fixed keyframe and the fixed landmark in the objective function based on the re-projection error.

The posture determination processing may be performed using both the reliability of the posture of the keyframe and the reliability of the position of the landmark 50. In this case, the posture determination unit 2040 determines whether each keyframe used in the posture determination processing is treated as a fixed keyframe or a floating keyframe. The posture determination unit 2040 determines whether each landmark 50 used in the posture determination processing is treated as a fixed landmark or a floating landmark. Then, the posture determination unit 2040 performs posture determination processing under the constraint that “The posture of the fixed keyframe is not changed and the position of the fixed landmark is not changed”. For example, in a case where posture determination processing is performed using bundle adjustment based on a re-projection error, the posture determination unit 2040 performs bundle adjustment under the constraint that “The posture of the fixed keyframe is not changed and the position of the fixed landmark is not changed”. As in the case of the map update processing, the posture determination unit 2040 may not include the re-projection error obtained from the fixed keyframe and the fixed landmark in the objective function based on the re-projection error.

### <Other Methods of Using Results of Posture Determination Processing and Map Update Processing>

The posture of the environment image 30 determined by the posture determination processing and the environment map 40 updated by the map update processing can be used for various processing. For example, the environment image 30 determined by the posture determination processing can be treated as the posture of the mobile object 10. Therefore, the posture of the environment image 30 determined by the posture determination processing can be used for movement control of the mobile object 10 or used for the user of the mobile object 10 to grasp the posture of the mobile object 10. The environment map 40 updated by the map update processing can be used for movement control of the mobile object 10, or can be used for obtaining a three-dimensional map of a place where the mobile object 10 is moved.

Here, the posture of the environment image 30 and the environment map 40 may be used by an apparatus other than the reliability determination system 2000. For example, in a case where an apparatus other than the reliability determination system 2000 controls the movement of the mobile object 10, the posture of the environment image 30 and the environment map 40 are provided from the reliability determination system 2000 to the apparatus. In a case where the user uses the posture of the mobile object 10 or the three-dimensional map represented by the environment map 40, the posture of the environment image 30 or the environment map 40 is provided from the reliability determination system 2000 to the terminal used by the user. Therefore, the reliability determination system 2000 is configured to be able to output the posture of the environment image 30 and the environment map 40 to another apparatus. The posture of the environment image 30 and the output of the environment map 40 are performed via, for example, the input/output interface 1100 and the network interface 1120.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

In the above-described example, the program includes a group of instructions (or software code) for causing a computer to perform one or more functions described in the example embodiments when being read by the computer. The program may be stored in a program or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted through a transitory computer-readable medium or a communication medium. As an example and not by way of limitation, the transitory computer-readable medium or the communication medium includes electrical, optical, acoustic, or other forms of propagated signals.

Some or all of the above-described example embodiments may be described as the following supplementary notes, but are not limited to the following supplementary notes.

### (Supplementary Note 1)

A reliability determination system comprising:
an acquisition means for acquiring a first environment image indicating an environment in which a mobile object moves;
a posture determination means for determining a posture of a camera corresponding to the first environment image based on an environment map including one or more keyframes which are environment images different from the first environment image, a posture of a camera corresponding to the keyframes, and landmarks corresponding to feature points on the keyframes; and
a determining means for determining reliability of data included in the environment map in accordance with an update result of the environment map updated based on a result of the determination.

### (Supplementary Note 2)

The reliability determination system according to supplementary note 1, wherein the data is the landmark or the keyframe.

### (Supplementary Note 3)

The reliability determination system according to supplementary note 1 or 2, wherein the determining means determines reliability of the data based on a difference between a value of the data before update and a value of the data after update.

### (Supplementary Note 4)

The reliability determination system according to supplementary note 3, wherein in a case where a difference between a value of the data before update and a value of the data after update is equal to or less than a threshold, the determining means sets reliability of the data to be higher than reliability before update.

### (Supplementary Note 5)

The reliability determination system according to supplementary note 2, wherein the determining means determines reliability of a position of the landmark based on a distance between a position of the landmark before update and a position of the landmark after update, and the number of the keyframes including the feature points corresponding to the landmark.

### (Supplementary Note 6)

The reliability determination system according to supplementary note 2, wherein the determining means determines reliability of a posture of the keyframe based on a difference between a posture before update corresponding to the keyframe and a posture after update corresponding to the keyframe and reliability of the landmark corresponding to a feature point on the keyframe.

### (Supplementary Note 7)

The reliability determination system according to supplementary note 5, comprising a map update means for updating a posture corresponding to the keyframe and a position of the landmark according to a result of the determination,
wherein the map update means updates a position of the landmark by adjusting a position of the landmark whose reliability is equal to or less than a threshold such that an objective function based on an error between a re-projected point and a feature point on the keyframe satisfies a predetermined condition, the re-projected point being obtained by projecting the landmark on the keyframe based on a position of the landmark corresponding to the feature point and a posture of the keyframe.

### (Supplementary Note 8)

The reliability determination system according to supplementary note 5, comprising a map update means for updating a posture corresponding to the keyframe and a position of the landmark according to a result of the determination,
wherein the map update means updates a posture of the keyframe by adjusting a posture of the keyframe whose reliability is equal to or less than a threshold such that an objective function based on an error between a feature point on the keyframe and a re-projected point satisfies a predetermined condition, the re-projected point being obtained by projecting the landmark on the keyframe based on a position of the landmark corresponding to the feature point and a posture of the keyframe.

### (Supplementary Note 9)

A reliability determination method executed by a computer, comprising:
an acquisition step of acquiring a first environment image indicating an environment in which a mobile object moves;
a posture determination step of determining a posture of a camera corresponding to the first environment image based on an environment map including one or more keyframes which are environment images different from the first environment image, a posture of a camera corresponding to the keyframes, and landmarks corresponding to feature points on the keyframes; and
a determining step of determining reliability of data included in the environment map in accordance with an update result of the environment map updated based on a result of the determination.

### (Supplementary Note 10)

The reliability determination method according to supplementary note 9, wherein the data is the landmark or the keyframe.

### (Supplementary Note 11)

The reliability determination method according to supplementary note 9 or 10, wherein, in the determining step, reliability of the data is determined based on a difference between a value of the data before update and a value of the data after update.

### (Supplementary Note 12)

The reliability determination method according to supplementary note 11, wherein, in the determining step, in a case where a difference between a value of the data before update and a value of the data after update is equal to or less than a threshold, setting reliability of the data to be higher than reliability before update.

### (Supplementary Note 13)

The reliability determination method according to supplementary note 10, wherein, in the determining step, determining reliability of a position of the landmark based on a distance between a position of the landmark before update and a position of the landmark after update, and the number of the keyframes including the feature points corresponding to the landmark.

### (Supplementary Note 14)

The reliability determination method according to supplementary note 10, wherein, in the determining step, determining reliability of a posture of the keyframe based on a difference between a posture before update corresponding to the keyframe and a posture after update corresponding to the keyframe and reliability of the landmark corresponding to a feature point on the keyframe.

### (Supplementary Note 15)

The reliability determination method according to supplementary note 13, comprising a map updating step of updating a posture corresponding to the keyframe and a position of the landmark according to a result of the determination,
wherein, in the map updating step, updating a position of the landmark is updated by adjusting a position of the landmark whose reliability is equal to or less than a threshold such that an objective function based on an error between a re-projected point and a feature point on the keyframe satisfies a predetermined condition, the re-projected point being obtained by projecting the landmark on the keyframe based on a position of the landmark corresponding to the feature point and a posture of the keyframe.

### (Supplementary Note 16)

The reliability determination method according to supplementary note 13, comprising a map updating step of updating a posture corresponding to the keyframe and a position of the landmark according to a result of the determination,
wherein, in the map updating step, updating a posture of the keyframe by adjusting a posture of the keyframe whose reliability is equal to or less than a threshold such that an objective function based on an error between a feature point on the keyframe and a re-projected point satisfies a predetermined condition, the re-projected point being obtained by projecting the landmark on the keyframe based on a position of the landmark corresponding to the feature point and a posture of the keyframe.

### (Supplementary Note 17)

A reliability determination apparatus comprising:
an acquisition means for acquiring a first environment image indicating an environment in which a mobile object moves;
a posture determination means for determining a posture of a camera corresponding to the first environment image based on an environment map including one or more keyframes which are environment images different from the first environment image, a posture of a camera corresponding to the keyframes, and landmarks corresponding to feature points on the keyframes; and
a determining means for determining reliability of data included in the environment map in accordance with an update result of the environment map updated based on a result of the determination.

### (Supplementary Note 18)

The reliability determination apparatus according to supplementary note 17, wherein the data is the landmark or the keyframe.

### (Supplementary Note 19)

The reliability determination apparatus according to supplementary note 17 or 18, wherein the determining means determines reliability of the data based on a difference between a value of the data before update and a value of the data after update.

### (Supplementary Note 20)

The reliability determination apparatus according to supplementary note 19, wherein the determining means adds a predetermined value to reliability of the data in a case where a difference between a value of the data before update and a value of the data after update is equal to or less than a threshold.

### (Supplementary Note 21)

The reliability determination apparatus according to supplementary note 18, wherein the determining means determines reliability of a position of the landmark based on a distance between a position of the landmark before update and a position of the landmark after update, and the number of the keyframes including the feature points corresponding to the landmark.

### (Supplementary Note 22)

The reliability determination apparatus according to supplementary note 18, wherein the determining means determines reliability of a posture of the keyframe based on a difference between a posture before update corresponding to the keyframe and a posture after update corresponding to the keyframe and reliability of the landmark corresponding to a feature point on the keyframe.

### (Supplementary Note 23)

The reliability determination apparatus according to supplementary note 21, comprising a map update means for updating a posture corresponding to the keyframe and a position of the landmark according to a result of the determination,
wherein the map update means updates a position of the landmark by adjusting a position of the landmark whose reliability is equal to or less than a threshold such that an objective function based on an error between a projected point and a feature point on the keyframe satisfies a predetermined condition, the projected point being obtained by projecting the landmark on the keyframe based on a position of the landmark corresponding to the feature point and a posture of the keyframe.

### (Supplementary Note 24)

The reliability determination apparatus according to supplementary note 21, comprising a map update means for updating a posture corresponding to the keyframe and a position of the landmark according to a result of the determination,
wherein the map update means updates a posture of the keyframe by adjusting a posture of the keyframe whose reliability is equal to or less than a threshold such that an objective function based on an error between a feature point on the keyframe and a re-projected point satisfies a predetermined condition, the re-projected point being obtained by projecting the landmark on the keyframe based on a position of the landmark corresponding to the feature point and a posture of the keyframe.

### REFERENCE SIGNS LIST

10 mobile object
20 camera
30 environment image
40 environment map
50 landmark
60 landmark information
62 landmark identifier
64 position
66 keyframe identifier
68 feature point
70 keyframe information
72 keyframe identifier
74 path
76 posture
80 graph
1000 computer
1020 bus
1040 processor
1060 memory
1080 storage device
1100 input/output interface
1120 network interface
2000 reliability determination system
2020 acquisition unit
2040 posture determination unit
2060 map update unit
2080 determining unit
3000 reliability determination apparatus

What is claimed is:

1. A reliability determination system comprising:
at least one memory that is configured to store instructions; and
at least one processor that is configured to execute the instructions to:
acquire a first environment image indicating an environment in which a mobile object moves;
determine a posture of a camera corresponding to the first environment image based on an environment map, which includes including one or more keyframes which are environment images different from the first environment image, a posture of a camera corresponding to the keyframes, and landmarks corresponding to feature points on the keyframes; and
reliability of data included in the environment map in accordance with a result of an update result of the environment map which is updated based on a result of the determination.

2. The reliability determination system according to claim 1, wherein the data is the landmark or the keyframe.

3. The reliability determination system according to claim 1, wherein the reliability of the data is determined based on a difference between a value of the data before update and a value of the data after update.

4. The reliability determination system according to claim 3, wherein the determination of the reliability of the data includes, in a case where the difference between the value of the data before update and the value of the data after update is equal to or less than a threshold, setting the reliability of the data to be higher than reliability before update.

5. The reliability determination system according to claim 2, wherein the determination of the reliability of the data includes determining reliability of a position of the landmark based on a distance between a position of the landmark before update and a position of the landmark after update and based on the number of the keyframes including the feature points corresponding to the landmark.

6. The reliability determination system according to claim 2, wherein the determination of the reliability of the data includes determining reliability of a posture corresponding to the keyframe based on a difference between a posture before update corresponding to the keyframe and a posture after update corresponding to the keyframe and based on reliability of the landmark corresponding to a feature point on the keyframe.

7. The reliability determination system according to claim 5,
wherein the at least one processor is configured further to update a position of the landmark by adjusting the position of the landmark whose reliability is equal to or less than a threshold such that an objective function based on an error between a re-projected point and a feature point on the keyframe satisfies a predetermined condition, the re-projected point being obtained by projecting the landmark on the keyframe based on a position of the landmark corresponding to the feature point and a posture corresponding to the keyframe.

8. The reliability determination system according to claim 5,
wherein the at least one processor is configured further to update posture corresponding to the keyframe by adjusting the posture corresponding to the keyframe whose reliability is equal to or less than a threshold such that an objective function based on an error between a feature point on the keyframe and a re-projected point satisfies a predetermined condition, the re-projected point being obtained by projecting the landmark on the keyframe based on a position of the landmark corresponding to the feature point and the posture of the keyframe.

9. A reliability determination method executed by a computer, comprising:
acquiring a first environment image indicating an environment in which a mobile object moves;
determining a posture of a camera corresponding to the first environment image based on an environment map, which includes one or more keyframes which are environment images different from the first environment image, a posture of a camera corresponding to the keyframes, and landmarks corresponding to feature points on the keyframes; and
determining reliability of data included in the environment map in accordance with a result of update of the environment map which is updated based on a result of the determination.

10. The reliability determination method according to claim 9, wherein the data is the landmark or the keyframe.

11. The reliability determination method according to claim 9, wherein the reliability of the data is determined based on a difference between a value of the data before update and a value of the data after update.

12. The reliability determination method according to claim 11, wherein the determination of the reliability of the data includes, in a case where the difference between the value of the data before update and the value of the data after update is equal to or less than a threshold, setting the reliability of the data to be higher than reliability before update.

13. The reliability determination method according to claim 10, wherein the determination of the reliability of the data includes determining reliability of a position of the landmark based on a distance between a position of the landmark before update and a position of the landmark after update and based on the number of the keyframes including the feature points corresponding to the landmark.

14. The reliability determination method according to claim 10, wherein the determination of the reliability of the data includes determining reliability of a posture corresponding to the keyframe based on a difference between a posture before update corresponding to the keyframe and a posture after update corresponding to the keyframe and based on reliability of the landmark corresponding to a feature point on the keyframe.

15. (canceled)

16. (canceled)

17. A reliability determination apparatus comprising:
at least one memory that is configured to store instructions; and
at least one processor that is configured to execute the instructions to:
acquire a first environment image indicating an environment in which a mobile object moves;
determine a posture of a camera corresponding to the first environment image based on an environment map, which includes one or more keyframes which are environment images different from the first environment image, a posture of a camera corresponding to the keyframes, and landmarks corresponding to feature points on the keyframes; and
determine reliability of data included in the environment map in accordance with a result of update the environment map which is updated based on a result of the determination.

18. The reliability determination apparatus according to claim 17, wherein the data is the landmark or the keyframe.

19. The reliability determination apparatus according to claim 17, the reliability of the data is determined based on a difference between a value of the data before update and a value of the data after update.

20. The reliability determination apparatus according to claim 19, wherein the determination of the reliability of the data includes adding a predetermined value to reliability of the data in a case where the difference between the value of the data before update and the value of the data after update is equal to or less than a threshold.

21. The reliability determination apparatus according to claim 18, wherein the determination of the reliability of the data includes determining reliability of a position of the landmark based on a distance between a position of the landmark before update and a position of the landmark after update and based on the number of the keyframes including the feature points corresponding to the landmark.

22. The reliability determination apparatus according to claim 18, wherein the determination of the reliability of the data includes determining reliability of a posture corresponding to the keyframe based on a difference between a posture before update corresponding to the keyframe and a posture after update corresponding to the keyframe and based on reliability of the landmark corresponding to a feature point on the keyframe.

23. (canceled)

24. (canceled)
